(19) United States
(12) Patent Application Publication
(10) Pub. No.: US 2021/0164771 A1
(43) Pub. Date: Jun. 3, 2021

(54) SYSTEM AND METHOD FOR DETECTING PARTICLE ACCUMULATION ON A SURFACE

(71) Applicant: 9260-2366 QUEBEC INC., Contrecoeur (CA)

(72) Inventor: Gérard NOËL, Ste-Julie (CA)

(21) Appl. No.: 17/250,304

(22) PCT Filed: Jul. 9, 2019
(86) PCT No.: PCT/CA2019/050943

§ 371 Date: Dec. 30, 2020

Related U.S. Application Data
(60) Provisional application No. 62/697,450, filed on Jul. 13, 2018.

(51) Int. Cl. G01B 11/06

(52) U.S. Cl. CPC G01B 11/0625; H04L 67/12

(57) ABSTRACT

A method and a system for monitoring matter accumulation on a surface, the system comprising an emitter emitting a flat or line beam parallelly to a surface to be monitored at a predetermined height above the surface to be monitored; a receiver positioned at the predetermined height above the surface to be monitored, the receiver being selected to one of: i) configured to detect a reflected beam and ii) configured to detect a transmitted beam, and a signaling unit sending a signal indicating that a threshold thickness of matter has accumulated on the surface to be monitored when one of: i) the receiver starts detecting a reflected beam and ii) the receiver stops detecting a transmitted beam.

### FIELD OF THE DISCLOSURE

The present disclosure relates to detection of particle. More specifically, the present disclosure is concerned with a system and method for detecting particle accumulation on a surface.

### BACKGROUND OF THE DISCLOSURE

In industrial or commercial buildings dust needs to be controlled so as to reduce dust explosion hazards.

Dust and particles accumulation may be detected by visual inspection or measurements in a building, and cleaning operation scheduled on a regular basis or depending on the visually observed level of deposition.

Control surfaces accumulating dust and particles positioned at places within the building may be visited on a regular basis so as to assess dust and particles buildup. Test films coated with an adhesive layer may be used to collect dust and particles from control surfaces for analysis.

There is a need in the art for a system and method for detecting particle accumulation on a surface.

### SUMMARY OF THE INVENTION

More specifically, in accordance with the present invention, there is provided a system for monitoring matter accumulation on a surface, comprising an emitter emitting a flat or line beam parallelly to a surface to be monitored at a predetermined height above the surface to be monitored; a receiver positioned at the predetermined height above the surface to be monitored, the receiver being selected to one of: i) configured to detect a reflected beam and ii) configured to detect a transmitted beam, and a signaling unit sending a signal indicating that a threshold thickness of matter has accumulated on the surface to be monitored when one of: i) the receiver starts detecting a reflected beam and ii) the receiver stops detecting a transmitted beam.

There is further provided a method for monitoring matter accumulation on a surface, comprising emitting a flat or line beam generally parallelly to a surface to be monitored at a predetermined height above the surface to be monitored; monitoring a variation in one of: i) transmission and ii) reflection of the beam at the predetermined height above the surface to be monitored and emitting a signal indicating that a threshold thickness of matter has accumulated on the surface to be monitored when said monitoring the variation in one of: i) transmission and ii) reflection of the beam at the predetermined height above the surface to be monitored indicates one of: i) stop of the transmission and ii) start of the reflection.

There is further provided a method comprising positioning a light beam source in relation to a target threshold height of matter accumulation to be detected on a surface, emitting a flat or line beam parallel to the surface, one of: i) detecting a reflected beam at the position of the light beam source and ii) detecting absence of a transmitted beam at a position opposite the light beam source across the surface being monitored; and triggering a signal.

There is further provided a system comprising an emitter directing a flat detection beam parallel to an accumulation surface, at a predetermined height from the surface as set by a positioning device, and a receiver positioned at the predetermined height from the surface and receiving a reflected or a transmitted beam, indicative of a height of matter being accumulated on the surface.

Other objects, advantages and features of the present invention will become more apparent upon reading of the following non-restrictive description of specific embodiments thereof, given by way of example only with reference to the accompanying drawings.

### BRIEF DESCRIPTION OF THE DRAWINGS

In the appended drawings:

FIG. 1 is a schematic view of a system according to an embodiment of an aspect of the present disclosure;

FIG. 2 is a schematic view of operation of a system according to an embodiment of an aspect of the present disclosure;

FIG. 3 shows a positioning device according to an embodiment of an aspect of the present disclosure;

FIG. 4 is an exploded view of the positioning device of FIG. 3;

FIG. 5 shows a system according to an embodiment of an aspect of the present disclosure;

FIG. 6 shows a system according to another embodiment of an aspect of the present disclosure;

FIG. 7 shows a system according to another embodiment of an aspect of the present disclosure;

FIG. 8 shows a system according to another embodiment of an aspect of the present disclosure;

FIG. 9 shows a system according to another embodiment of an aspect of the present disclosure;

FIG. 10 is an exploded view of the system of FIG. 9; and

FIG. 11 shows positioning of the system of FIG. 9 on a beam.

### DESCRIPTION OF ILLUSTRATIVE EMBODIMENTS

The present disclosure is illustrated in further details by the following non-limiting examples.

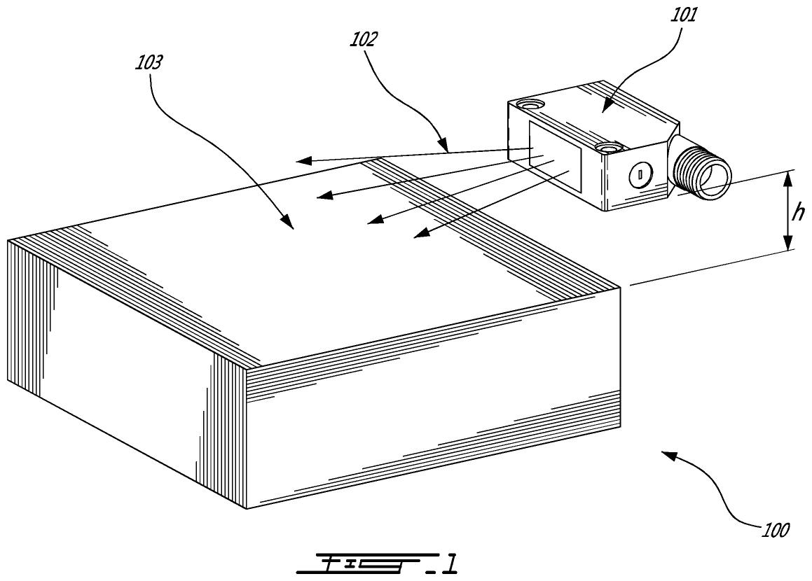

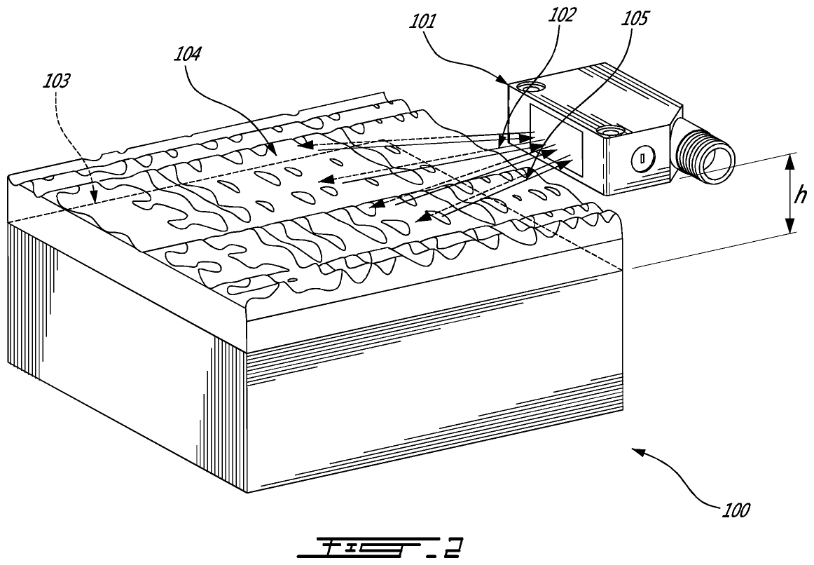

A system 100 according to an embodiment of an aspect of the present disclosure as illustrated in FIGS. 1 and 2 for example, comprises a unit 101 emitting a flat or line beam 102 generally parallelly to a surface 103, i. e. at an angle of about 0° relative to the top plan of the surface 103, at a height (h) above the surface 103. In absence of matter on the path of the beam 102 on the surface 103 above the height (h), no signal is sent back to the unit 101 (see FIG. 1). A soon as the thickness of matter 104 accumulated on the surface 103 reaches the height (h) on the surface 103 as shown in FIG. 2 for example, a part 105 of the beam 102 is reflected back to the unit 101. In return, the unit 101 emits a signal indicating that a threshold accumulation of matter, dust or particles, as detected using the relative position between the unit 101 and the surface 103 as indicated by the height (h) of the beam 102 above the surface 103, on the monitored surface 103.

The unit 101 may be a photoelectric device, comprising an emitter and a receiver and driven by a power source, so that when matter accumulating on the monitored surface 103 reaches the threshold thickness (h), at least part of the light beam sent by the emitter is returned and detected by the receiver, which in turn triggers a signal via a signaling unit such as an antenna secured to the casing of the unit 102 for example, and emitting to a WIFI antenna of the premises (not shown)

Matter accumulation on the surface may thus be monitored, by preselecting the height (h) above the surface 103 of emission of the flat or line beam generally parallelly to the monitored surface, independently of the density of the accumulation on the surface, which may vary across the surface that is being monitored.

A positioning device may be used to select the relative position between the unit 101 and the surface being monitored, i. e. the height (h) of the beam 102 above the surface 103 in examples of FIGS. 1 and 2. The height (h) is selected so as to detect a target thickness of matter accumulated on the surface being monitored.

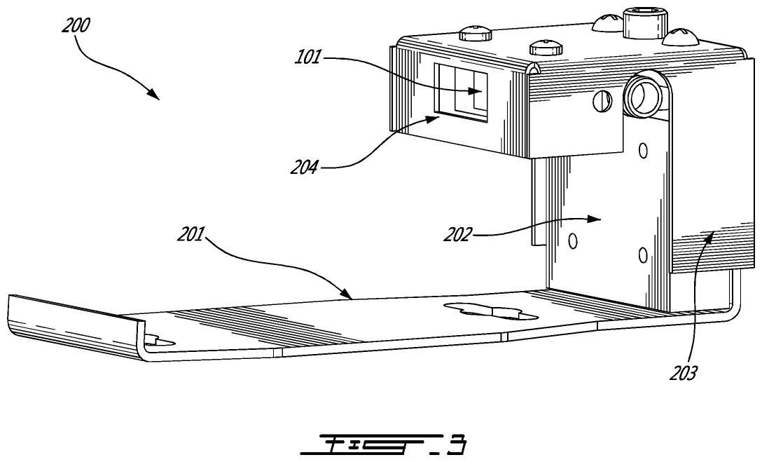

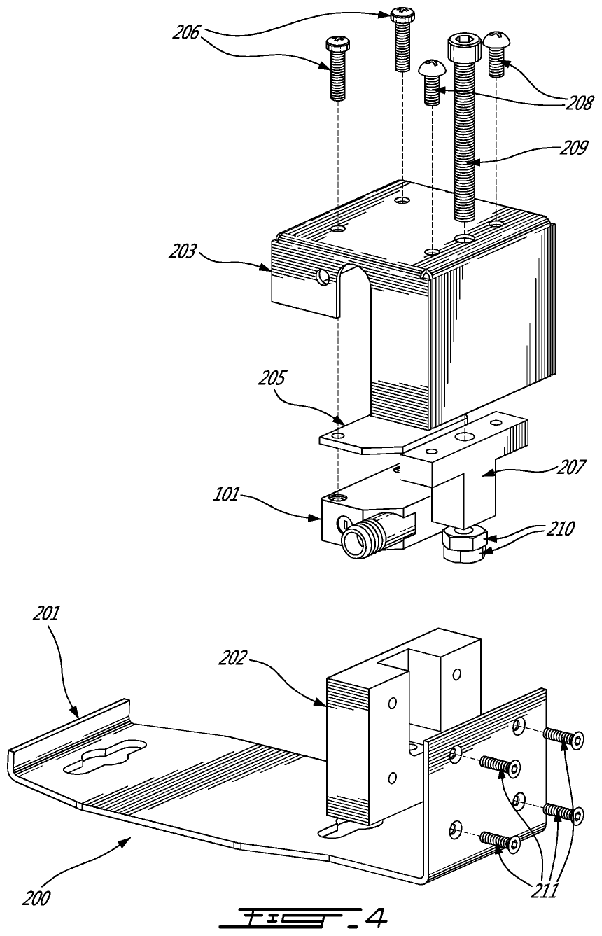

According to an embodiment of an aspect of the present disclosure illustrated in FIGS. 3-4, a positioning device 200 comprises a base plate 201 supporting a housing mounted on a support 202. The unit 101 is held within the housing, which comprises a window 204 in a front surface thereof for passage of emitted beams 102 and reflected beams 105 by the unit 101.

In a example illustrated in FIG. 4, the support 202 is secured to the base plate 201 by screws 211 for example. The support 202 comprises a slot 213 receiving the foot of a T-shape member 207. A cover 203 is secured to the top arms of the T-shape member 207 (see screws 208). A bolt 209 is positioned from above the cover 203 within the foot of the T-shape member 207, a distal end thereof being secured in the threaded bottom end of the foot of the T-shape member 207 by nuts 210 for example, or by a combination of a nut 210 and a plastic ring for example, allowing free rotation of the bolt 209 for raising and lowering the T-shape member 207 within the slot 213 of the support 202.

The housing to receive the unit 101 is formed by a spacing plate 205 supported by screws 206 from the top surface of the cover 203 and the cover 203 for example.

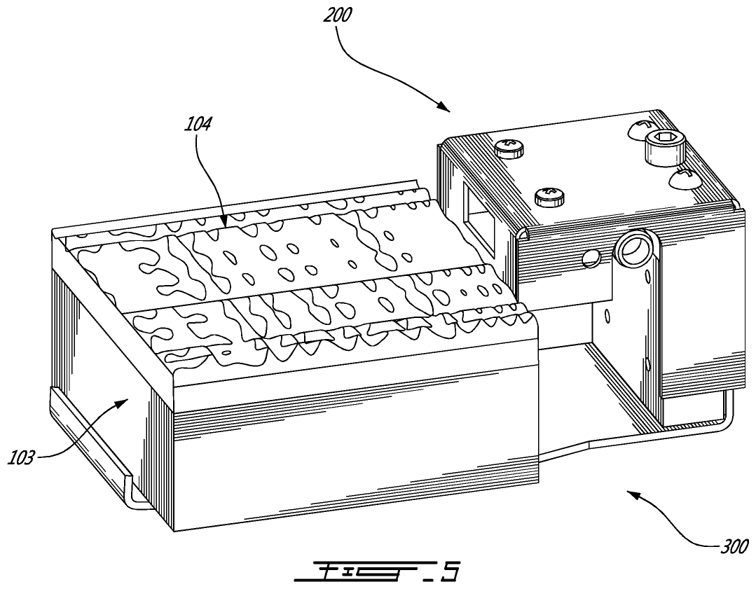

Once thus assembled, the positioning device 200 may be used to adjust the height of the unit 101, by rotation of the bolt 209, thereby lifting or lowering the cover 203, and the unit 101 within the housing, from and to the base plate 201, in relation to the surface 103 to be monitored as illustrated in FIG. 5, thereby setting the detection threshold.

Alternatively, a reference gauge, such as a plate of a thickness corresponding to the threshold height (h) of accumulated dust to be detected, may be used for precise positioning of the unit 101 relative to the surface 103. The reference gauge is positioned directly on the surface to be monitored surface 103, and the unit 101 is positioned in relation to the gauge at the minimum height above the surface to be monitored surface 103 at which the beam 102 starts to be reflected back by hitting the gauge wall; then, the gauge is removed from the surface to be monitored surface 103. When accumulation 104 on the surface 103 reaches a height corresponding to the gauge, part of the beam 102 emitted by the unit 101 is then reflected back and an alarm is triggered.

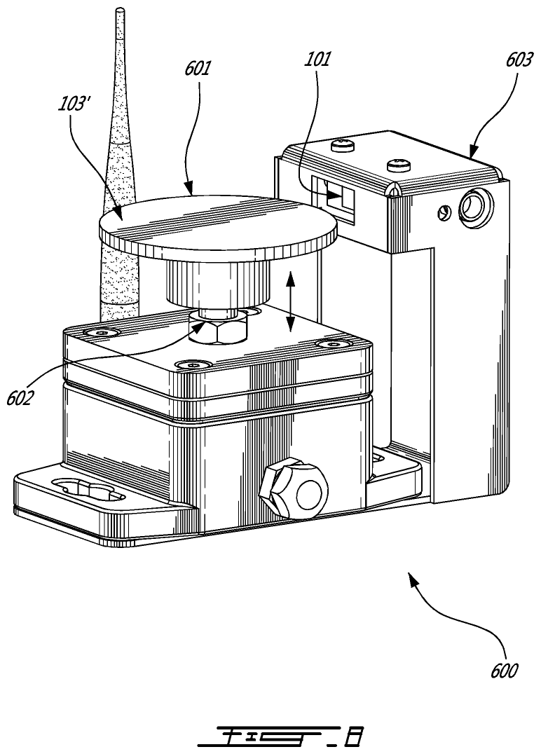

Alternatively, the unit 101 may be positioned at a fixed location in relation to a movable test surface, and the vertical distance between the top of the test surface and the beam emitted by the unit 101 is adjusted to the predetermined threshold height (h) of accumulated dust to be detected by moving the test surface vertically (see for instance FIG. 8 discussed hereinbelow).

Calibration parameters of the unit 101 may need to be adjusted, depending of the nature of the accumulated matter. For example the index of reflection of the dust may vary according to the nature of the product contained in the dust, wood such as maple having a reflection index of 0.55 to 0.65 while concrete may have a reflection index of 0.4 to 0.5 for instance. Thus, the unit 101 is selected or adjusted in sensitivity depending on the nature of matter under monitoring so that the alarm is indeed triggered when accumulation thereof reaches the predetermined height h.

The calibration of the beam emitted above the surface to be monitored allows to adjust the capture distance of the unit 101, i. e the propagation distance of the emitted beam, i.e. the sensing range of the unit 101 so as to avoid false alarm by detection of the presence of nearby objects, such as a beam fin the environment for example.

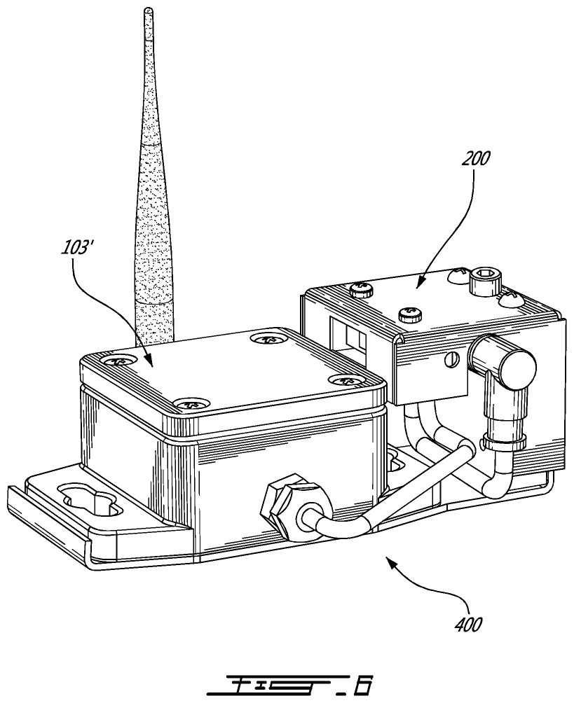

FIG. 6 shows a system according to another embodiment of an aspect of the present disclosure. The system 400 comprises a positioning device 200 as described hereinabove in relation to FIG. 3 for example, positioning the unit 101 on the base plate 201 in relation with a test surface 103′. In the same way as described in relation to FIG. 2 for example, the surface that accumulates matter is the test surface 103′ and when the accumulation height on the test surface 103′ reaches the height (h) of the beam emitted by the unit 101 above the test surface 103′, the unit 101 receives a reflected beam 105 and sends a signal to a wireless emitter (not shown) that is located within a housing below the test surface 103′, which in turn may send a remote signal via a router and an alert may be sent by internet for example.

The detecting light beam source and the detector of reflected beam may be a same device as described hereinabove or separate devices located at the same height (h) relative to the surface relative to the surface to be monitored. Still alternatively, the light beam source and the light beam detector may be separate devices, arranged in a facing relationship on opposite edges of the surface to be monitored for example, at the height (h) relative to the surface; in this case, when the accumulation of matter on the surface to be monitored reaches the predetermined threshold height (h), the beam emitted by the light beam source on a first side is blocked by the matter accumulated above the height (h) on the surface being monitored and thus the detector on the opposite side stops receiving a signal, thereby triggering an accumulation signal.

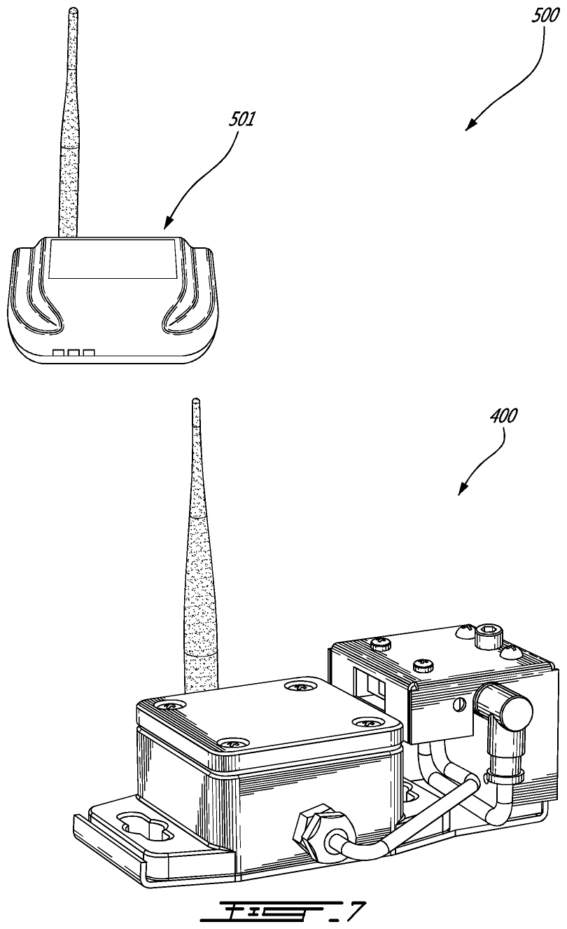

As schematically illustrated in FIG. 7, a monitoring system 500 according to an embodiment of an aspect of the present disclosure comprises the system 400 connected to a router 501 allowing data collection and transfer via an internet network.

FIG. 8 shows a system 600 comprising a turntable 601 pivotally mounted on a top surface of a casing housing a wireless emitter (not shown) as described in relation to FIG. 6 for example using a nut and threaded rod combination 602 according to an embodiment of an aspect of the present disclosure. The turntable 601 is adjustable in height above the top surface of the emitter 401 in order to calibrate the position of the unit 101, the support 603 being fixed and maintaining the unit 101 at a fixed height. In this embodiment, the top surface of the turntable 601 is the test surface on which dust accumulation is monitored.

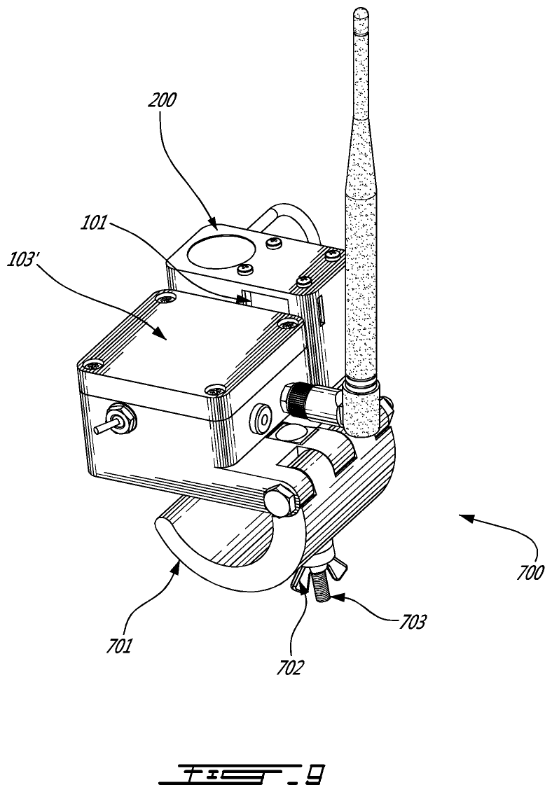

In an embodiment illustrated in FIGS. 9-11, a system is shown with a positioning clamp 701 according to an embodiment of an aspect of the present disclosure. As described hereinbefore, the unit 101 is referenced in height relative to the test surface 103′.

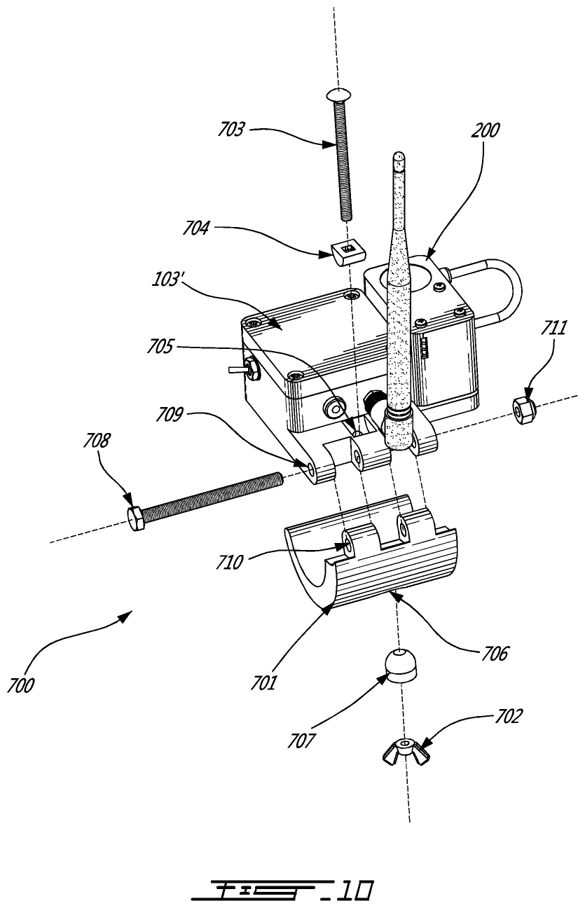

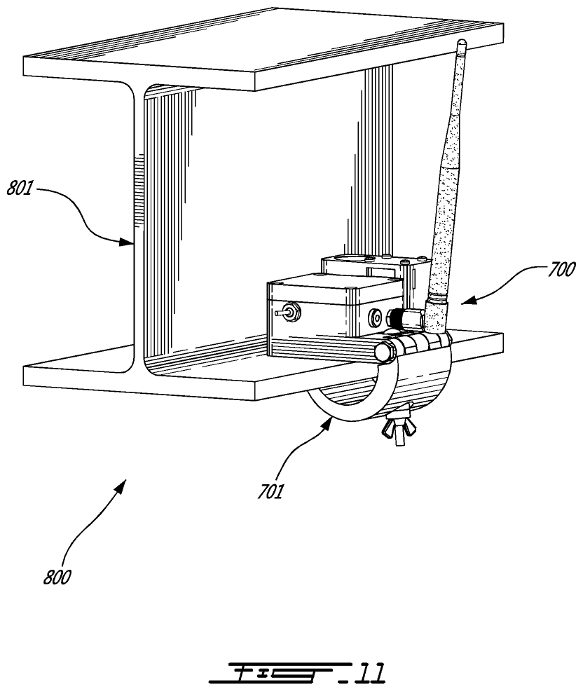

The clamp 701 may be fastened to the base plate 201 by a wing nut 702 and bolt 703 arrangement for example (FIGS. 9, 10) and used to position the system in the environment as illustrated for example in FIG. 11.

As detailed in FIG. 10, the base plate 201 may comprise an extension at the base 709 thereof, for connection of the clamp 701 by a hinge joint 709/710 via a bolt 708 which passes through cavities 709/710 of the joint and is held by a clamping nut 711, for example.

The clamp 701 may be further secured using the bolt 703 passing through a half-cylinder 704 through a cavity 705 of the extension of the base 709 of the box of the emitter 401 and through the joint 709/710 down a cavity 706 in the clamp 701 not shown, where it engages a locking ball 707 held in position by the wingnut 702. The clip 701 may be disconnected from the system base plate 201 and thus from the unit 101 and the test surface 103′ in cases the system does not require anchoring. In addition the clip (701) may be of different size to accommodate the fixation under different conditions.

FIG. 11 illustrates the system 700 held in position relative to a I-beam 801 in an environment to be monitored by the clamp 701.

A method according to an embodiment of an aspect of the present disclosure comprises positioning a light beam source in relation to a target threshold height (h) of matter accumulation on a surface, emitting a flat or line beam parallelly at the height (h) above the surface, detecting a reflected beam at the position of the light beam source or absence of a transmitted beam at a position opposite the light beam source across the surface being monitored; and in return causing an alarm to be sent.

The word dust used herein may encompass particles of different sizes, contaminants, or matter accumulating on a surface. The present system and method may be applied to accumulation of a solid or a viscous matter such as a viscous liquid on a surface, or a gas provided it may reflect the beam emitted by the unit 101.

There is thus provided a system comprising an emitter directing a flat detection beam parallel to an accumulation surface, at a predetermined height (h) from the surface as set by a positioning device, and a receiver positioned at the predetermined height from the surface and receiving a reflected or a transmitted beam, indicative of a height (h) of matter being accumulated on the surface.

There is thus provided a system comprising a dust accumulation detector and an alarm signaling when a preset accumulation threshold is reached, allowing an autonomous monitoring of dust accumulation in industrial or commercial buildings, setting the threshold height according to regulations, such as a 3 mm allowance (⅛ inches) for example when dealing with insurance companies. The alarm may be any one of an audio or visual signal, or a combination thereof, for example.

The scope of the claims should not be limited by the embodiments set forth in the examples, but should be given the broadest interpretation consistent with the description as a whole.

1. A system for monitoring matter accumulation on a surface, comprising an emitter emitting a flat or line beam parallelly to a surface to be monitored at a predetermined height above the surface to be monitored; a receiver positioned at the predetermined height above the surface to be monitored, said receiver being selected to one of: i) configured to detect a reflected beam and ii) configured to detect a transmitted beam, and a signaling unit sending a signal indicating that a threshold thickness of matter has accumulated on the surface to be monitored when one of: i) said receiver starts detecting a reflected beam and ii) said receiver stops detecting a transmitted beam.

2. The system of claim 1, comprising a positioning device, the positioning device being used to select a relative position between the emitter and the receiver and the surface being monitored according to the threshold thickness of accumulated matter to be detected on the surface being monitored.

3. The system of claim 1, comprising a positioning device, the positioning device comprising a base plate mounting the emitter and the receiver in relation to the surface to be monitored.

4. The system of claim 1, comprising a test surface, said emitter and said receiver being at a fixed position at a same height, and a height of said test surface relative to said height of the emitter and the receiver is adjusted according to the threshold thickness to be detected on the surface to be monitored.

5. The system of claim 1, comprising a reference gauge, said reference gauge having a thickness corresponding to the threshold thickness to be detected on the surface to be monitored, said reference gauge being positioned directly on the surface to be monitored surface for positioning the emitter and the receiver at one of: i) a height above the surface to be monitored at which a beam starts to be reflected back by hitting the reference gauge and ii) a height above the surface to be monitored at which a beam stops to be transmitted by hitting the reference gauge; the gauge being removed from the surface to be monitored surface when the emitter and the receiver are positioned.

6. The system of claim 1, wherein, said receiver being configured to detect a reflected beam, the emitter and the receiver are positioned on a same side relative to the surface to be monitored.

7. The system of claim 1, wherein said receiver and said emitter are comprised in a photoelectric device, said receiver are configured to detect a reflected beam, and the emitter and the receiver are positioned on a same side relative to the surface to be monitored.

8. The system of claim 1, wherein one of: i) said receiver being configured to detect a reflected beam, the emitter and the receiver are positioned on a same side relative to the surface to be monitored, and ii) said receiver being configured to detect a transmitted beam, the emitter and the receiver are positioned in a facing relationship on opposite sides of the surface to be monitored.

9. The system of claim 1, said receiver being configured to detect a reflected beam, the emitter and the receiver are positioned on a same side relative to the surface to be monitored, said signaling unit comprises a wireless emitter, and, when an accumulation height on the surface to be monitored reaches the threshold thickness, the receiver receives a reflected beam and sends a signal to the wireless emitter, which in turn sends a remote signal via a router and an alert is sent by internet.

10. The system of claim 1, connected to a router for data collection and transfer.

11. A method for monitoring matter accumulation on a surface, comprising emitting a flat or line beam generally parallelly to a surface to be monitored at a predetermined height above the surface to be monitored; monitoring a variation in one of: i) transmission and ii) reflection of the beam at the predetermined height above the surface to be monitored and emitting a signal indicating that a threshold thickness of matter has accumulated on the surface to be monitored when said monitoring the variation in one of: i) transmission and ii) reflection of the beam at the predetermined height above the surface to be monitored indicates one of: i) stop of the transmission and ii) start of the reflection.

12. The method of claim 11, comprising the emitter and the receiver in relation to the surface to be monitored,

13. The method of claim 11, comprising positioning a reference gauge of a thickness corresponding to the threshold height of accumulated matter to be detected on the surface to be monitored surface; positioning the emitter and the receiver at one of: i) a height above the surface to be monitored at which a beam starts to be reflected back by hitting the reference gauge and ii) a height above the surface to be monitored at which a beam stops to be transmitted by hitting the reference gauge; and removing the gauge from the surface to be monitored.

14. The method of claim 11, comprising providing a test surface, positioning the emitter and the receiver at a fixed position at a same height, and adjusting a height of the test surface relative to the height of the emitter and the receiver according to the threshold thickness to be detected on the surface to be monitored.

15. The method of claim 11, comprising positioning an emitter and a receiver on a same side relative to the surface to be monitored, and at the predetermined height above the surface to be monitored according to the threshold thickness of accumulated matter to be detected on the surface being monitored.

16. The method of claim 11, comprising positioning an emitter and a receiver in a facing relationship on opposite edges of the surface to be monitored, and at the predetermined height above the surface to be monitored according to the threshold thickness of accumulated matter to be detected on the surface being monitored.

17. The method of claim 11, comprising, when said monitoring indicates one of: i) a stop of the transmission and ii) a start of the reflection, sending a signal to a wireless emitter, which in turn sends a remote signal via a router and an alert is sent by internet.

18. The method of claim 11, comprising data collection and remote data transfer.

19. A method comprising positioning a light beam source in relation to a target threshold height of matter accumulation to be detected on a surface, emitting a flat or line beam parallel to the surface, one of: i) detecting a reflected beam at the position of the light beam source and ii) detecting absence of a transmitted beam at a position opposite the light beam source across the surface being monitored; and triggering a signal.

20. (canceled)
